(19) United States
(12) Patent Application Publication
(10) Pub. No.: US 2004/0195888 A1
(43) Pub. Date: Oct. 7, 2004

(54) Configurable vehicle seat

(75) Inventor: Dale J. Frye, Port Hueneme, CA (US)

Correspondence Address: FOLEY & LARDNER LLP, 777 East Wisconsin Avenue, Milwaukee, WI, 53202-5306, US

(73) Assignee: Johnson Controls Technology Company

(21) Appl. No.: 10/816,278

(22) Filed: Apr. 1, 2004

Related U.S. Application Data
(60) Provisional application No. 60/460,323, filed on Apr. 3, 2003.

(51) Int. Cl. B60N 2/30

(52) U.S. Cl. 297/354.1

(57) ABSTRACT

A configurable vehicle seat. The configurable vehicle seat comprises a seat base with a seat cushion supported by the seat base. A seatback is coupled to the seat base. The seatback includes a configurable portion, wherein the configurable portion can be selectively moved to one of a seating position and a cargo blocking position. The configurable portion can be coupled to the seatback with the hinge mechanism. Another embodiment of the configurable vehicle seat provides the hinge mechanism with an actuator to move the configurable portion.

### CROSS-REFERENCE TO RELATED PATENT APPLICATIONS

This application claims benefit of provisional patent application 60/460,323, filed Apr. 3, 2003 under 35 USC 119(e) and is incorporated herein by this reference in its entirety.

### BACKGROUND OF THE INVENTION

The present invention relates generally to the field of vehicle seats and more particularly relates to a vehicle seat having a seat back having a configurable member.

It is well known in the art to provide an opening between a passenger area and cargo storage area of a vehicle. For example, between a cab portion and cargo box of a pick-up truck or between the passenger compartment and trunk of a passenger automobile. It is also well known in the art to provide a folding seat back to allow access to the cargo storage area through the opening in the partition between the passenger area and cargo storage area of a vehicle.

It is known to provide a vehicle seat, for example, an automotive seat having a reclineable back. It is also known to provide a vehicle seat having a reclineable back and an independently movable seat base. It is also known to provide a vehicle seat having an adjustable lumbar consisting of a flexible member having a first end anchored and a second end moved with respect to the first end to cause the flexible member to vary its shape to provide adjustable support within the lumbar region of an automotive seat.

Notwithstanding the known devices, there remains a significant need to develop a vehicle seat which is capable of inhibiting movement of an object. Further, there remains a need to provide a vehicle seat that includes a flexible seat back that automatically adjusts to inhibit movement of an object. Further, there remains a need to provide a vehicle seat having a seat back that constitutes at least a part of a partition between a cargo storage area and a passenger area.

It is desirable to provide a vehicle seat that provides one or more of these or other advantageous features. Other features and advantages will be made apparent from the present description.

### SUMMARY OF THE INVENTION

There is provided a configurable vehicle seat. The configurable vehicle seat comprises a seat base with a seat cushion supported by the seat base. A seatback is coupled to the seat base. The seatback includes a configurable portion, wherein the configurable portion can be selectively moved to one of a seating position and a cargo blocking position. The configurable portion can be coupled to the seatback with the hinge mechanism. Another embodiment of the configurable vehicle seat provides the hinge mechanism with an actuator to move the configurable portion.

There is also provided a method for preventing cargo movement from a cargo storage area into a passenger area of the vehicle. The method comprises the steps of providing a vehicle seat having a seatback with a configurable portion. Moving the seatback to a nonseating position. Moving the configurable portion of the seatback to a cargo inhibiting position.

### BRIEF DESCRIPTION OF THE DRAWINGS

FIG. 1 is a partial perspective illustration of an exemplary embodiment of a configurable vehicle seat, including one vehicle seat in a seating-configuration (right side) and one vehicle seat in a cargo inhibiting position (left side).

FIG. 2 is a partial perspective illustration of an exemplary embodiment of a configurable vehicle seat of a pick-up type truck in a cargo inhibiting position.

### DETAILED DESCRIPTION OF THE EXEMPLARY EMBODIMENTS

Before beginning the detailed description of an exemplary embodiment, several general comments are warranted about the applicability and the scope of the present invention.

First, the illustrations relate to a seat (also can be referred to as a chair) particularly adapted for motor vehicles, such as cars, SUVs, vans, trucks, buses and the like, but the invention is applicable also to seating used in aircraft, railroad vehicles, nautical vehicles or other environments.

Second, the seat of the present invention is illustrated in the FIGURE as a padded seat having certain contours, trim and the like. While this configuration is presently preferred, a wide variety of seat configurations and appearances will benefit from use of the mechanical support and movement mechanisms. Also the exterior of the seat can be covered by fabric, vinyl, leather or other materials known and used in the seating art.

Third, with regard to the seat described later herein, substantial modifications can be made without departing from the invention's intended scope. For example, while certain mechanical systems are described to move seat components to achieve certain results, other mechanisms, manual or powered could be substituted therefore. For example, where a screw drive is used in moving the thorax pivot location, other mechanical equivalents including, but not limited to, four bar linkages, air or hydraulic cylinders, air bladders, rack and pinion systems, cams and cables, gears, etc. could be employed. Another example is that for a pelvis support, i.e., a pair of clam-shell like devices (which are themselves already known in the art). They could be replaced by other known or subsequently developed support mechanisms. These mechanisms do not, in and of themselves, form part of the present invention, but when combined with the other pivot, support, rotation and moving mechanisms define the invention and result in more comfortable seating for the occupant.

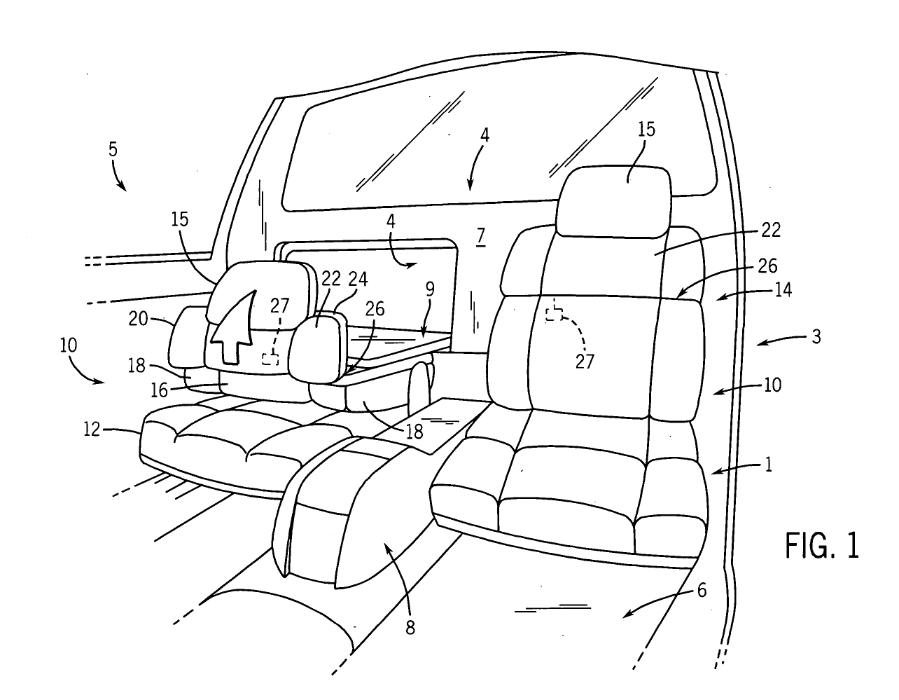

Referring generally to the Figure and in particular to FIG. 1 there is shown a vehicle seat 10 for use in a vehicle 5 of any known type. The vehicle seat 10 includes a seat base 12 which supports a cushioned seat 11 and a seat back 14 pivotally connected to the seat base 12. The seat 10 can be either a manually adjustable seat or may be provided with electric motors to provide automated adjustment and electronic control of the seat. Such manipulation can be accomplished by the use of a change of position mechanism coupled to the seat 14 back and seat base 12. The change of position mechanism provides for the back frame to move in proportional relation to the seat base 12 at a predetermined ratio, for example, moving the seat 11 one and a half millimeter per degree of seat 14 back movement. The seat 10 is connected to the floor of the support structure 6 of a vehicle 5 in any of a variety of configurations or designs which allow for the movement and adjustment of the seat 10 within the vehicle 5. The vehicle seat 10 may optionally include a headrest which may also be adjustable with respect to an occupant of the seat 10 such as any known or appropriate headrest.

The seat back 14 of the vehicle seat 10 preferably includes a central portion cushion 16 and a pair of side bolsters 18 positioned on the sides of the cushion 16. The cushion 16 is preferably contoured to receive and support the back of an occupant of the vehicle seat 10. The side bolsters 18 are also preferably aligned with respect to the cushion 16 and contoured to provide an angled, gradual support of the lateral side portions of an occupant 0 of the vehicle seat 10. The cushion 16 and side bolsters 18 preferably include a foam material (not shown) and a cover of any appropriate or known material such as cloth, vinyl, leather, etc. The cushion 16 and bolsters 18 include support frames as more fully described below.

The seat back 14 further includes a back frame including a cover of any appropriate or known material such as cloth, vinyl, leather, etc. and which preferably matches the cover material of the seat 11, back cushion 16, side bolsters 18 and seat base 12. However, it should be understood that a different material may be used on any element.

Referring now to the figures, FIG. 1 is a partial perspective illustration of an exemplary embodiment of a configurable vehicle seat 10. FIG. 1 illustrates two vehicle seats 10. The one in the right side of the figure illustrates a seating-configuration of the vehicle seat 10 and the vehicle seat 10 on the left side of the figure illustrates a cargo inhibiting position seat. A console 8 may separate the vehicle seats 10.

A vehicle 5 typically includes a vehicle support structure 6, for example, a frame chassis. The vehicle 5 may also have a passenger area 3 and a cargo storage area 4. A partition 7 typically separates the passenger area 3 from the cargo storage area 4. In a pick-up truck type vehicle 5, the cargo storage area 4 is generally referred to as a cargo box. In a passenger automobile type vehicle 5, the cargo storage area 4 is typically referred to as the trunk.

A vehicle seat 10 includes a seat base 12 which supports a seat cushion 11 and a seat back 14. A headrest 15 may also be included as well as side bolsters 18.

The configurable vehicle seat 10 includes a configurable portion 20. One embodiment of the configurable vehicle seat 10 provides that the configurable portion 20 of the vehicle seat 10 constitutes approximately one-third of the length of the seat back 14. A hinge mechanism 26 couples the configurable portion 20 to the seat back 14. The hinge mechanism 26 may be operated manually or it may be motorized or manipulated by linkage or actuators 27, for example cables, hydraulic or pneumatic cylinders.

The configurable portion 20 includes a cushion 22 which typically extends along the full width of the configurable portion 20 and includes a cushion back wall 24. The cushion back wall 24 can be composed of metal or a composition material of sufficient strength to inhibit any cargo from moving from the cargo storage area 4 into the passenger area 3 beyond the configurable portion 20 of the vehicle seat 10.

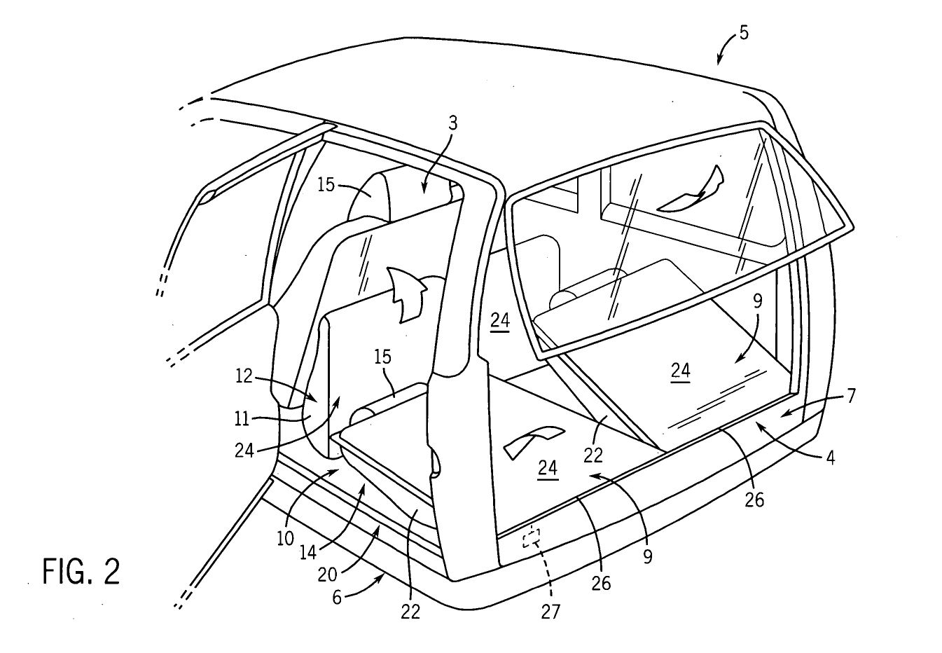

FIG. 2 illustrates another embodiment of the configurable vehicle seat 10. In the illustrated embodiment, the cushion back wall 24 is configured to form a portion of the partition 7 when the seat back 14 is in an upright (seating-configuration) position. When the seat back 14 is in the cargo inhibiting position, the cushion back wall 24 forms a part of the support structure for the cargo as illustrated in FIG. 2.

It should be noted that the broad arrows in the figures depict the proper motion of the several elements as will be appreciated by one ordinarily skilled in the art.

Although the disclosed embodiments have been described in some detail, it should be understood that various changes, substitutions and alterations can be made to the embodiments without departing from their spirit and scope.

What is claimed is:

1. A configurable vehicle seat comprising:
a seat base;
a seat cushion supported by the seat base; and
a seat back coupled to the seat base, with the seat back including a configurable portion, wherein the configurable portion can be selectively moved to one of a seating position and a cargo blocking position.

2. The configurable vehicle seat of claim 1, wherein the configurable portion is coupled to the seat back with a hinge mechanism.

3. The configurable vehicle seat of claim 2, wherein the hinge mechanism includes an actuator to move the configurable portion.

4. The configurable vehicle seat of claim 3, wherein the actuator is selected from the group including a cable, a hydraulic cylinder, and a pneumatic cylinder.

5. The configurable vehicle seat of claim 1, wherein the seat back is composed of one of a metal and composition material.

6. The configurable vehicle seat of claim 1, wherein the seat back includes a headrest.

7. The configurable vehicle seat of claim 1, wherein the seat back includes a side bolster.

8. A method for preventing cargo movement from a cargo storage area into a passenger area of a vehicle, the method comprising the steps of:
providing a vehicle seat having a seat back with a configurable portion;
moving the seat back to a non-seating position; and
moving the configurable portion to a cargo inhibiting position.

9. The method of claim 8, including the steps of providing a hinge mechanism and coupling the hinge mechanism to the seat back and the configurable portion.

10. The method of claim 9, including the steps of providing an actuator and coupling the actuator to the hinge mechanism.

11. The method of claim 10, including the step of selecting the actuator from a group including a cable, a hydraulic cylinder, and a pneumatic cylinder.

12. The method of claim 8, wherein the seat back is composed of one of a metal and composition material.

13. The method of claim 8, wherein the seat back includes a headrest.

14. The method of claim 8, wherein the seat back includes a side bolster.
